(19) United States
(12) Patent Application Publication
(10) Pub. No.: US 2017/0228668 A1
(43) Pub. Date: Aug. 10, 2017

(54) COMPREHENSIVE DOOR-TO-DOOR TRIP PLANNING AND PURCHASING PROCESS AND SYSTEM THAT PROVIDES ONGOING SUPPORT TO A TRAVELER THROUGHOUT A TRIP

(71) Applicant: Khalid R. Oreif, Pacific Palisades, CA (US)

(72) Inventor: Khalid R. Oreif, Pacific Palisades, CA (US)

(21) Appl. No.: 15/040,209

(22) Filed: Feb. 10, 2016

(51) Int. Cl. G06Q 10/02; G06Q 10/10

(52) U.S. Cl. CPC G06Q 10/025; G06Q 10/1095; G06Q 50/12

(57) ABSTRACT

A comprehensive door-to-door trip planning and purchasing process and system is disclosed that provides ongoing support to a traveler throughout a trip. The comprehensive door-to-door trip planning and purchasing process includes planning for multi-destination trips.

### BACKGROUND

Embodiments of the invention described in this specification relate generally to travel planning, and more particularly, to comprehensive travel planning, purchasing, and support-providing systems and processes.

Current travel planning and booking systems and mechanisms are typically based on a single-transaction, product centric approach. In other words, the focus of most existing travel planning and booking systems is on selling a product/or booking a single service (e.g., hotel) rather than providing a customer with a full, comprehensive itinerary based on a single destination or multiple destinations. For instance, the customer has to book each flight/hotel/car as a stand alone transaction.

In contrast, there is a noticeable lack of focus on providing comprehensive travel solutions which include door-to-door coverage for several travel-related aspects, including flights, hotel reservations, car rentals, entertainment options, time-limited offerings, and other such possible aspects of travel, for either single destination trips or multi-destination trips. Because the existing travel planning and booking systems are focused on one transaction at a time, the traveler has to execute separate transactions and piece it together to form a master plan for an overall multi-destination trip.

Therefore, what is needed is a way to provide comprehensive travel solutions which include door-to-door planning and purchasing coverage of travel bookings, itineraries, and details in relation to single- or multi-destination trips.

### BRIEF DESCRIPTION

Some embodiments of the invention include a comprehensive door-to-door trip planning and purchasing process and system that provides ongoing support to a traveler throughout a trip. In some embodiments, the comprehensive door-to-door trip planning and purchasing process includes planning for multi-destination trips. In some embodiments, the comprehensive door-to-door trip planning and purchasing process provides a background criteria check service that identifies a predefined itinerary criteria, such as price or availability, and notifies a person of availability at the predefined itinerary criteria. In some embodiments, the background criteria check service includes a booking option to perform at least one of (i) notifying the person of the itinerary criteria and availability and (ii) automatically booking the itinerary at the predefined criteria.

The preceding Summary is intended to serve as a brief introduction to sonic embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a comprehensive door-to-door trip planning and purchasing process in some embodiments.

FIG. 2 is a continuation of the comprehensive door-to-door trip planning and purchasing process of FIG. 1.

FIG. 3 is a continuation of the comprehensive door-to-door trip planning and purchasing process of FIG. 2.

FIG. 4 conceptually illustrates a schematic view of data sources in a comprehensive door-to-door trip planning and purchasing system in some embodiments.

FIG. 5 conceptually illustrates a schematic view of a comprehensive door-to-door trip planning and purchasing system in some embodiments.

FIG. 6 conceptually illustrates an electronic system with sonic embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

As stated above, travel planning and booking is typically product-centric, being focused on selling a product rather than on providing an itinerary to a traveler going on a trip with one or more destinations. Generally, a traveler (or customer, user, individual, agent, etc.) has to book each itinerary item (e.g., flight, hotel, car, etc.) in a separate stand-alone transaction. Embodiments of the invention described in this specification solve such problems by a comprehensive door-to-door trip planning and purchasing process and system that provides ongoing support to a traveler throughout a trip. The solution offers iterative and cumulative trip planning and purchasing so that the user can construct a single (complete) itinerary. In other words, the trip planning and purchasing process of the present disclosure provides a comprehensive solution that takes into account multiple aspects of a trip so that the trip is planned and booked or purchased door-to-door with ongoing support offered throughout the trip, whether for single destination trips or multi-destination trips.

In some embodiments, the comprehensive door-to-door trip planning and purchasing process includes planning for a single destination trip. In some embodiments, the comprehensive door-to-door trip planning and purchasing process includes planning for a multi-destination trip. In some embodiments, the comprehensive door-to-door trip planning and purchasing process provides a background criteria check service that identifies a predefined itinerary criteria, such as price or availability, and notifies a person of availability at the predefined itinerary criteria. In some embodiments, the background criteria check service includes a booking option to perform at least one of (i) notifying the person of the itinerary criteria and availability and (ii) automatically booking the itinerary at the predefined criteria.

### I. DOOR-TO-DOOR TRIP PLANNING AND PURCHASING PROCESS

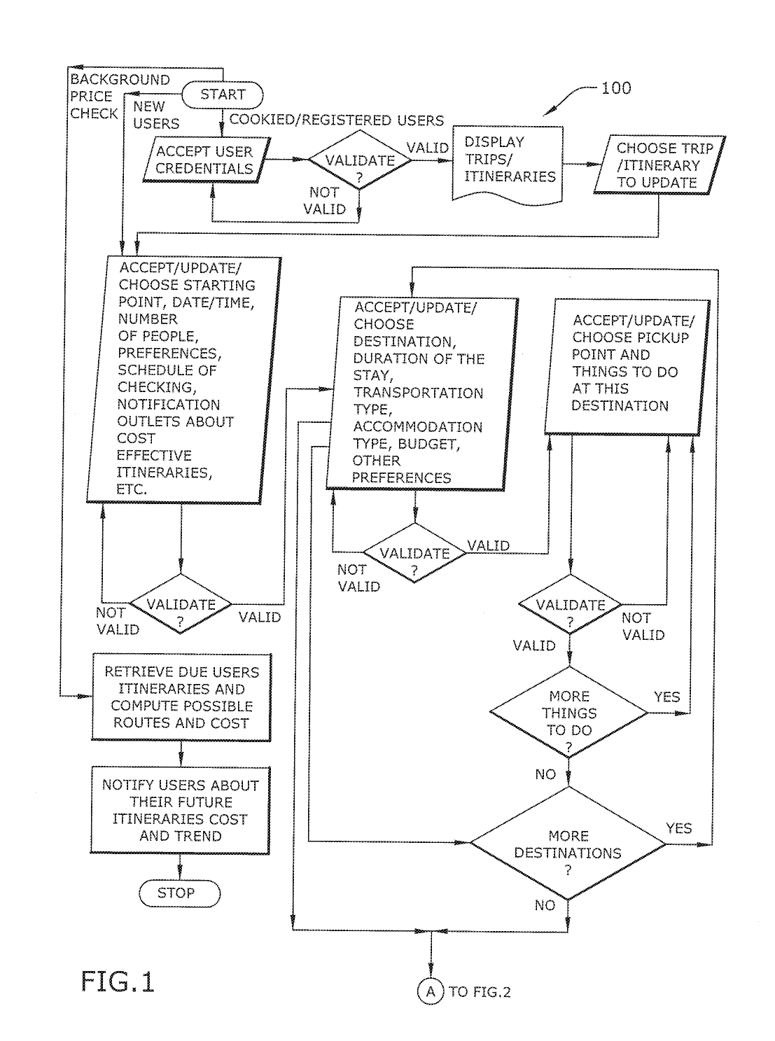

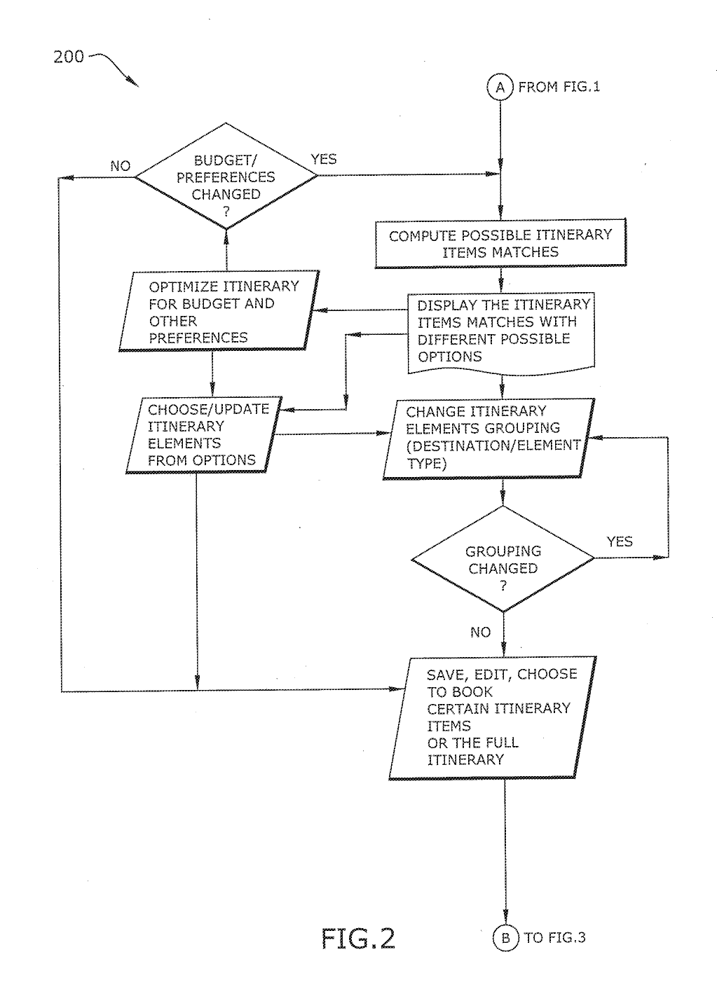

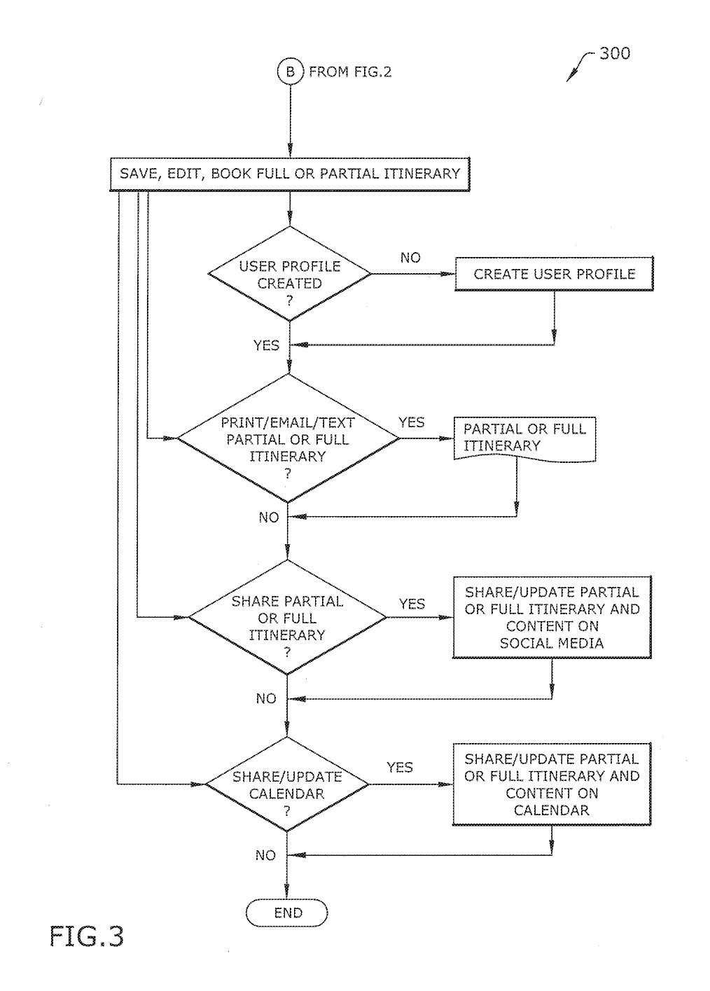

By way of example, FIGS. 1-3 conceptually illustrate a comprehensive door-to-door trip planning and purchasing process. The comprehensive door-to-door trip planning and purchasing process is illustrated in three phases corresponding to three sub-processes, namely, a first phase 100 (as in FIG. 1), a second phase 200 (as in FIG. 2), and a third phase (as in FIG. 3). The comprehensive door-to-door trip planning and purchasing process may be implemented as a trip planning and purchasing software program that allows a user (e.g., a traveler, an agent arranging a trip for a traveler, etc.) to arrange comprehensive travel plans in connection with one or more destinations from start to finish (door-to-door). When running on a computing device, the comprehensive door-to-door trip planning and purchasing software program provides comprehensive planning, purchasing/booking, and support in relation to a single destination or multi-destination trip.

In FIG. 1, the first phase 100 of the comprehensive door-to-door trip planning and purchasing process performs initial user logon operations, itinerary loading or creation, and a set of operations for selecting and validating itinerary items in relation one or more destinations.

Turning to FIG. 2, the second phase 200 of the comprehensive door-to-door trip planning and purchasing process performs budget optimizations in relation to the destinations selected for the trip. In some embodiments, the comprehensive door-to-door trip planning and purchasing process first displays one or more options that match the current trip itinerary (established in the first phase 100). When options are selected for inclusion in the trip itinerary, some embodiments of the comprehensive door-to-door trip planning and purchasing process updates itinerary element groupings.

Now turning to FIG. 3, the third phase 300 of the comprehensive door-to-door trip planning and purchasing process performs operations to save, edit, and/or book full or partial itineraries. This may include reviewing the user credentials to ensure that the user has created a user profile to which the itinerary can be associated when saved. The process may also output itineraries and items in an itinerary (e.g., print, email, text, etc.), share complete or partial itineraries (e.g., share with colleagues, family members, etc.), and share or update one or more calendars (e.g., user's calendar and other calendars of other people, associates, friends, family, colleagues, etc.) to include one or more of the items booked for the itinerary. Then the process ends.

When implemented as a software program, the comprehensive door-to-door trip planning and purchasing process provides a multi-destination travel shopping cart that covers flights, hotels, car rentals, attractions, restaurants, house rentals, car sharing, trains, subway, bus rides, check-in, sharing every step of the itinerary, budget optimization, calendar integration for both pleasure and business travelers. This improves upon currently existing travel planning options by allowing a user to arrange several trip items for a first destination and several other trip items for a second destination. If or when a change occurs during the trip (e.g., an extra night stay at the first destination), the process provides full support in updating the remaining travel arrangements (e.g., providing available options for re-booking travel, lodging, appointments, etc.). The process is thus iterative and cumulative for door-to-door travel arrangements and/or transactions, with ongoing support during the trip.

### II. DOOR-TO-DOOR TRIP PLANNING AND PURCHASING SYSTEM

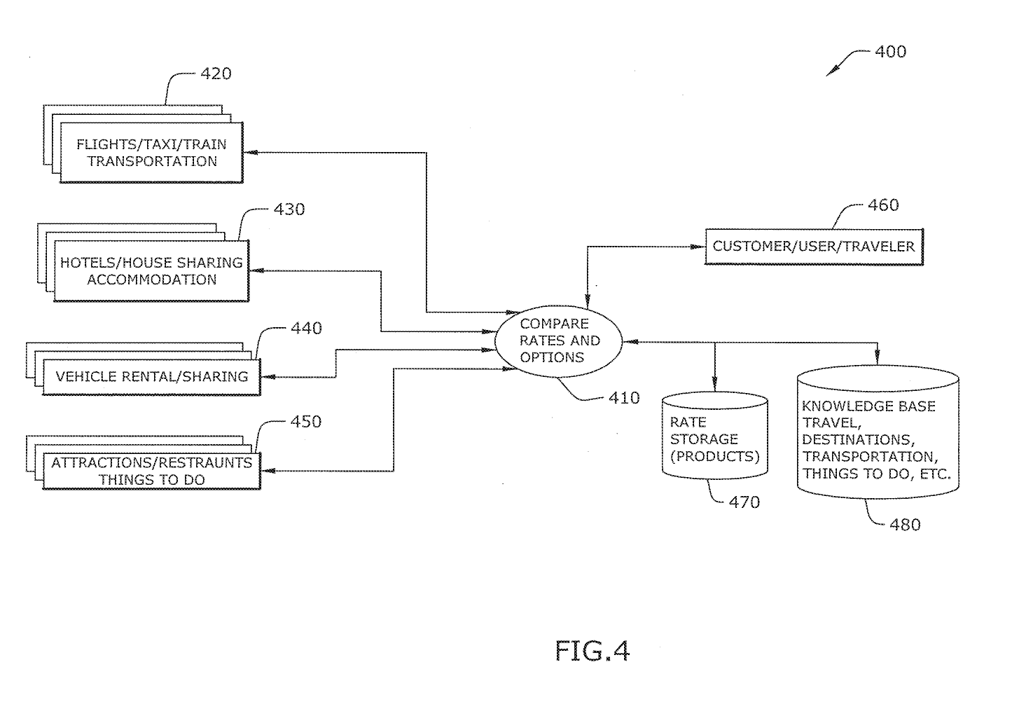

By way of example, FIG. 4 conceptually illustrates a schematic view of data sources in a comprehensive door-to-door trip planning and purchasing system 400. As shown in this figure, the comprehensive door-to-door trip planning and purchasing system 400 provides a multi-destination travel shopping cart 410 that covers point-to-point transportation 420 items (e.g., flights, taxis, train transportation, subway, bus rides, etc.), traveler accommodation 430 items (e.g., hotels, house rentals, house sharing, etc.), vehicular transportation 440 items (e.g., car rentals, car sharing, etc.), and destination site 450 items (e.g., attractions, restaurants, etc.).

A user 460 (e.g., customer, user, traveler, etc.) of the system 400 may interact with a graphical user interface (GUI) that includes a visual shopping cart 410 into which the user may select and add the travel-related items. In some embodiments, the comprehensive door-to-door trip planning and purchasing system 400 cumulatively adds such items, providing updates on travel planning options based on the cumulative trip items already added. For instance, when the user selects a destination (e.g., Chicago) and adds a flight to the destination, the system 400 is able to intelligently retrieve relevant Chicago-related attractions in and around the time during which the user is planning to travel to Chicago (based on the flight), and thereby provide very clear options to the user when planning an overall travel itinerary. In this way, the user 460 of the comprehensive door-to-door trip planning and purchasing software program can add one or more of these (or other) travel items iteratively in an effort to arrange an overall trip.

The comprehensive door-to-door trip planning and purchasing software program may retrieve rate information and/or data from a rate data storage 470, such as a cloud database or local database that maintains an index of products and services with pricing and rate information. In some embodiments, the index of products and services and the associated pricing and rate information is routinely updated to include new products or services, and to update pricing and rate information when changes occur.

The comprehensive door-to-door trip planning and purchasing software program may also retrieve travel destination items, transportation items, attractions, and other such information from a knowledge base 480, such as a cloud database with updated listings of travel destinations, attractions, transportation, and other such details. In some embodiments, the knowledge base is routinely updated to include new destinations, transportation, attractions, and other such items.

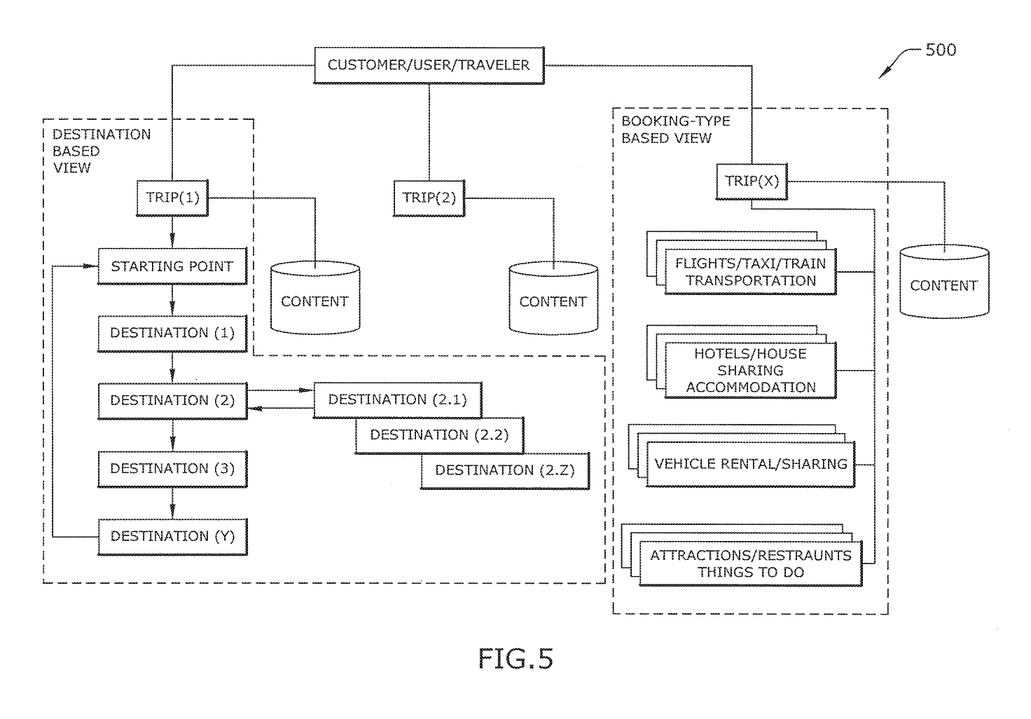

Turning to FIG. 5, which conceptually illustrates a comprehensive door-to-door trip planning and purchasing system 500, a traveler may interact with the system in any of several view-based manners. In this figure, a destination based view and booking-type based view are shown, allowing the traveler to build a mule-destination travel itinerary complete with trip items at each destination, transportation arranges, and accommodation bookings.

By way of example, a traveler may logon to the comprehensive door-to-door trip planning and purchasing software program to interact with the multi-destination travel shopping cart for planning a trip. The following use-case includes a list of possible operations to plan a trip and is intended to be exemplary only and it is not intended that this list be used to limit the comprehensive door-to-door trip planning and purchasing system 500 of the present application to just this use-case. Persons having ordinary skill in the art relevant to the present disclosure may understand there to he equivalent use-cases, steps, and/or operations that may be substituted within the present disclosure without changing the essential function or operation of the comprehensive door-to-door trip planning and purchasing system 500.

1. The traveler enters the starting point, starting date/time, number of people, preferences, etc.

2. The traveler enters where to go, duration of the stay, type of transportation and accommodation if applicable. The traveler also can enter what to do during this stay at this stage or come back to iterate on it later. This covers means of transportation such as airport pickups to hotels, what to do in a city every day, attractions to visit, etc.

3. The traveler can add another Destination and repeat Point 2 above.

4. The system 500 displays the itinerary items matches for the user/traveler to choose from.

5. The system 500 offer options to group the itinerary elements based on destination or element type.

6. At any time the user/traveler can save, choose to book certain itinerary items or the full itinerary

7. At any time in future the user/traveler can come back, update, make additions, make deletions, make extra bookings under that itinerary.

8. At any time during the trip, the user/traveler can share on social media the itinerary or different parts of the itinerary and load/exchange relevant contents.

9. At any time during the trip, the user/traveler can share update the calendar based on the itinerary.

10. As an option a budget could be used starting from step 1 to optimize the travel path/itinerary.

The comprehensive door-to-door trip planning and purchasing system 500 generally works by retrieving data from various sources (e.g., content databases) about transportation (e.g., flights, taxis, trains, buses, etc.) accommodation (e.g., hotels, house/apartment sharing, etc.), vehicle rental/sharing, attractions, restaurants and things to do to combine it with user preferences and knowledge base about destinations to come up with the user itinerary for the trip. The comprehensive door-to-door trip planning and purchasing system 500 also stores these itineraries and content for future updates so that the user can iterate on it. The traveler/user can choose preferences such as airlines, train, bus, taxi, etc. or hotel, house, apartment, couch etc. that impact the system responses if available to or in the destination. The traveler/user can add unlimited number of destinations. if added each will be part of the trip itinerary for planning and transactions. The traveler/user can plan unlimited number of activities in every destination if added each will be part of the trip itinerary for planning and transactions. If the user entered a budget, the system will try to optimize and offer itinerary elements within the budget in addition to other elements that will go off budget as an option. If the user enter one destination only, the comprehensive door-to-door trip planning and purchasing system 500 will still offer the service of booking for this destination.

The above-described embodiments of the invention are presented for purposes of illustration and not of limitation. While these embodiments of the invention have been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

### III. ELECTRONIC SYSTEM

Many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, and EPROMs. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

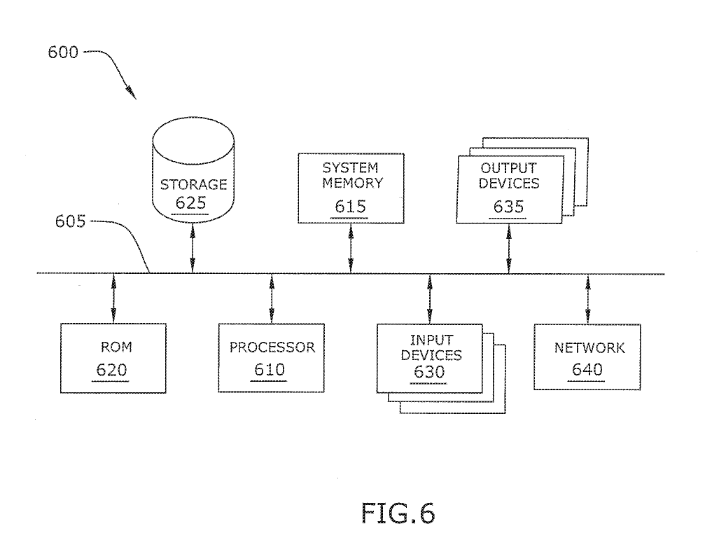

FIG. 6 conceptually illustrates an electronic system 600 with which some embodiments of the invention are implemented. The electronic system 600 may be a computer, web server, phone, PDA, or any other sort of electronic device. Such an electronic system includes various types of computer readable media and interfaces for various other types of computer readable media. Electronic system 600 includes a bus 605, processing unit(s) 610, a system memory 615, a read-only 620, a permanent storage device 625, input devices 630, output devices 635, and a network 640.

The bus 605 collectively represents all system, peripheral, and chipset buses that communicatively connect the numerous internal devices of the electronic system 600. For instance, the bus 605 communicatively connects the processing unit(s) 610 with the read-only 620, the system memory 615, and the permanent storage device 625.

From these various memory units, the processing unit(s) 610 retrieves instructions to execute and data to process in order to execute the processes of the invention. The processing unit(s) may be a single processor or a multi-core processor in different embodiments.

The read-only-memory (ROM) 620 stores static data and instructions that are needed by the processing unit(s) 610 and other modules of the electronic system. The permanent storage device 625, on the other hand, is a read-and-write memory device. This device is a non-volatile memory unit that stores instructions and data even when the electronic system 600 is off. Some embodiments of the invention use a mass-storage device (such as a magnetic or optical disk and its corresponding disk drive) as the permanent storage device 625.

Other embodiments use a removable storage device (such as a floppy disk or a flash drive) as the permanent storage device 625. Like the permanent storage device 625, the system memory 615 is a read-and-write memory device. However, unlike storage device 625, the system memory 615 is a volatile read-and-write memory, such as a random access memory. The system memory 615 stores some of the instructions and data that the processor needs at runtime. In some embodiments, the invention's processes are stored in the system memory 615, the permanent storage device 625, and/or the read-only 620. For example, the various memory units include instructions for processing appearance alterations of displayable characters in accordance with some embodiments. From these various memory units, the processing unit(s) 610 retrieves instructions to execute and data to process in order to execute the processes of some embodiments.

The bus 605 also connects to the input and output devices 630 and 635. The input devices enable the user to communicate information and select commands to the electronic system. The input devices 630 include alphanumeric keyboards and pointing devices (also called “cursor control devices”). The output devices 635 display images generated by the electronic system 600. The output devices 635 include printers and display devices, such as cathode ray tubes (CRT) or liquid crystal displays (LCD). Some embodiments include devices such as a touchscreen that functions as both input and output devices.

Finally, as shown in FIG. 6, bus 605 also couples electronic system 600 to a network 640 through a network adapter (not shown). In this manner, the computer can be a part of a network of computers (such as a local area network (“LAN”), a wide area network (“WAN”), or an intranet), or a network of networks (such as the Internet). Any or all components of electronic system 600 may be used in conjunction with the invention.

These functions described above can be implemented in digital electronic circuitry, in computer software, firmware or hardware. The techniques can be implemented using one or more computer program products. Programmable processors and computers can be packaged or included in mobile devices. The processes may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For instance, FIGS. 1-3 conceptually illustrate a process in which the specific operations of the process may not be performed in the exact order shown and described. Specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

I claim:

1. A non-transitory computer readable medium storing a program which, when executed by at least one processing unit of a computing device, provides a comprehensive door-to-door trip planning and purchasing interface for a user to arrange a multi-destination trip, said program comprising sets of instructions for:
receiving a first set of trip settings comprising a starting point of a multi-destination trip, a starting date of the multi-destination trip, a starting time of the multi-destination trip, and a set of preferences associated with a user who is traveling for the multi-destination trip;
receiving a second set of trip settings comprising a set of destinations the user will visit during the multi-destination trip, and, for each destination, a duration of stay at the destination;
identifying a set of options that are consistent with the starting date, the starting time, and the duration of stay at each destination during the multi-destination trip;
displaying the identified set of options for the user to select from to create a comprehensive door-to-door itinerary for the multi-destination trip; and
receiving a set of optional trip selections from the identified set of options;
generating a comprehensive door-to-door itinerary for the multi-destination trip based on the first set of trip settings, the second set of trip settings, and the set of optional trip selections; and
completing at least one of saving the generated itinerary and booking one or more of the received settings and the optional trip selections.

2. The non-transitory computer readable medium of claim 1, wherein the second set of trip settings further comprises a type of accommodation at each destination.

3. The non-transitory computer readable medium of claim 1, wherein the second set of trip settings further comprises a type of transportation at each destination.

4. The non-transitory computer readable medium of claim 1, wherein the set of options comprises a set of destination attractions the user intends to visit at one or more destinations of the multi-destination trip.

5. The non-transitory computer readable medium of claim 1, wherein the set of options comprises a set of restaurants the user intends to visit at one or more destinations of the multi-destination trip.

6. The non-transitory computer readable medium of claim 1, wherein the set of options comprises a set of available calendar meeting times during which the user can engage with others at one or more destinations of the multi-destination trip.

7. The non-transitory computer readable medium of claim 1, wherein the second set of trip settings and the set of options are able to be changed throughout the multi-destination trip.

8. The non-transitory computer readable medium of claim 7, wherein the program further comprises sets of instructions for:
determining whether user made a change to at least one of a setting in the second set of trip settings and a selected option in the identified set of ons;
identifying any inconsistent settings in the second set of trip settings when the user made a change to the setting in the second set of trip settings;
identifying any inconsistent selected options when the user made a change to the setting in the selected options; and
providing a set of options for the user to select an alternative setting that is consistent with the change in the first setting, said alternative setting being an available attraction to replace the second setting in the second set of trip settings.

9. The non-transitory computer readable medium of claim 8, herein the program further comprises a set of instructions for providing a set of alternative options for the user to select an alternative option that is consistent with the change in the selected option.

10. The non-transitory computer readable medium of claim 8, wherein the program further comprises a set of instructions for providing a set of updated settings for the user to select an alternative setting that is consistent with the change in the setting.
